(19) United States
(12) Patent Application Publication
(10) Pub. No.: US 2005/0119901 A1
(43) Pub. Date: Jun. 2, 2005

(54) Method, receiving server, and computer program module for the automatic reception and forwarding of document processing orders

(76) Inventor: Peter Ullrich, Feldkirchen (DE)

Correspondence Address: SCHIFF HARDIN, LLP;PATENT DEPARTMENT, 6600 SEARS TOWER, CHICAGO, IL, 60606-6473, US

(21) Appl. No.: 10/502,911

(22) PCT Filed: Jan. 13, 2003
(86) PCT No.: PCT/EP03/00243

(30) Foreign Application Priority Data
Jan. 31, 2002 (DE) 102 03 868.6

(51) Int. Cl. G06F 17/60

(52) U.S. Cl. 705/1

(57) ABSTRACT

A method and a computer system for processing document processing orders such as for example print jobs from a plurality of files is provided. According to the method, the files are temporally stored in a directory of a receiving server, the directory is automatically checked at regular intervals for newly added files and every newly added file is supplied for processing. The check is controlled by means of a computer program, in which a control mode can be selected from at least two of the following adjustments and allocated to the directory: the files contain only processing data, the files contain processing data and a job-related control file, or the files contain processing data and have a parameterized file name for the purpose of processing.

### BACKGROUND OF THE INVENTION

1. Field of the Invention

The present invention relates generally to a method, a receiving server, and a computer program module for the automatic receiving and forwarding of document processing orders. In particular, it relates to the handling of print orders that are sent to high-performance printing systems, whose print speed can be from about 40 to more than 1000 pages per minute. The print data are thereby often individually formed in page-by-page fashion, and the print data are thereby in particular assembled page-by-page from static data and from variable data.

2. Description of the Related Art

For processing high-performance print orders, the print servers are often used that obtain print data from a data source, prepare these data for printing, whereby in certain circumstances the data are converted from a first data format to a second data format, and finally send the data stream converted in this way directly to a connected printer.

In the publication “Das Druckerbuch” [The Printer Book], by Dr. Gerd Goldmann (pub.), sixth edition (May 2001), Océ Printing Systems GmbH, Poing, Chapter 14 describes what are known as Océ PrismaPro server systems, which are able to process print orders such as those referred to above. For this purpose, various system components are provided that provide a large degree of automation in the production of a print order. By means of a print job manager, print orders can be produced at an arbitrary client console in a client network, and these orders can be sent to an order distribution system. The print job manager can not only send print orders; but also, by means of the print job manager it is possible in the system to produce or to load various resource data, that is, predetermined data that can be applied to a plurality of print orders, and to store these data on the print server for multiple use. What are known as job tickets are also used, in which items of accompanying information to the print orders are stored, for example concerning the use of already-existing resource data, the number of copies, the input/output interface, and the queue.

In the processing of print orders in a print production environment, it is of decisive importance to enable a processing of the print orders that is as efficient and flexible as possible, in order to achieve an effective use of the connected production printer, and thus a high degree of productivity.

A typical print data format in electronic production print environments is the Advanced Function Presentation format (AFP). This print data format is described for example in International Business Machines Corp. (IBM) publication no. F-544-3884-01, having the title “AFP Programming Guide and Line Data Reference.”

### SUMMARY OF THE INVENTION

The present invention enables the production of document processing orders from one or more data files in as flexible a fashion as possible and with a high degree of productivity.

This is provided by a method for automatic receiving and forwarding of a document processing order for processing at least one data file, including the steps of: sending at least one data file to a directory of a receiving server; automatically checking the directory at regular time intervals for newly added data files; supplying each newly added data file for further processing; controlling the checking step by a computer program; permitting selection of a control mode from at least two settings selected from the following: the data files contain only processing data, the data files contain processing data and an order-individual control data file, the data files contain processing data, and for further processing each data file has a parameterized data filename; and allocating selected settings to the directory.

### BRIEF DESCRIPTION OF THE DRAWINGS

FIG. 1 is a functional block diagram of a high performance printing system according to the principles of the present invention; and

FIG. 2 is a screen slot of a graphical user interface for determining parameters for producing a print order.

### DETAILED DESCRIPTION OF THE PREFERRED EMBODIMENTS

According to the present invention, for the production of a document processing order, in particular a print order, from at least one data file, the data file is sent to a particular directory of a receiving server, and the directory is automatically checked at regular time intervals for newly added data files, and a new print order is produced from each newly added data file, or the data file is added to an existing print order for further processing. The time intervals for checking the directory may be configured as desired. The automatic checking is controlled by means of a computer program. A control mode can thereby be selected from at least two directory-related settings and can be allocated to the directory. In a first directory-related setting, the temporarily stored data files contain only processing data, in particular print data, and in a second setting the data files contain processing or print data as well as a control data file that is specific to the individual print order. In a third setting, the data files contain print data and have data file names that are respectively parametrized for further processing.

For sending the data files to the directory, a wide variety of data file commands, such as copy, move, ftp (file transfer protocol), etc., can be used. The directory can also be mounted on to another directory, whereby the directory appears as a locally stored directory in a different computer (in other words is logically located on other computers), but is physically stored on a different system. The data can also be temporarily stored therein before being forwarded.

It has been recognized that in the production of such print orders control data files, such as for example a job ticket as referred to above, often contain information that is at least almost identical for a plurality of print orders. Embodiments of the present invention now make it possible to use such universal items of control information multiple times, that is, for a plurality of print orders, and, optionally, to effect the complete or partial acceptance of such control data files in a second document processing or print order, or in a temporary storage directory, coupled therewith, of the receiving or the print server. The partial acceptance is thereby controlled in particular by the parametrized data file names or by the control data file that is concomitantly sent, whereby for parametrization inside the data file name of the data files associated with a print order, code designations are indicated in segments for various predefined items of control information. Predefined items of control information can thereby be taken over, or items of control information differing from a standard control data file can be indicated. The settings that are selected and determined before the production of the print order are then maintained consistently in the production of the print order by the data files produced in a data source, via the data files stored in the print server or in the temporary storage directory. In this way, a very efficient production of the print order is possible, because only parameters that are slightly modified need be newly determined, if necessary. In addition, the present invention makes it possible to produce print orders very easily from a wide variety of user systems. In the present invention, print parameters can be indicated very easily and very flexibly; for example, they can be predefined in data file names or in a separately sent control data file.

The parameterizations of the data file names characterize, in particular, different options and/or operational steps for predetermined options and/or operational steps of predetermined parameters of a job ticket data file that is standardly allocated to the print order.

In addition to or instead of the available processing steps, an individual process program can be allocated to the processing of the print data file; this program subjects the incoming data files to a separate processing, and can subsequently produce one or more print orders, or can again store the data in a directory provided for this purpose, for further processing.

The method according to the present invention for producing the print order is suitable for print data of all types, for example for PostScript data and for Page Command Language (PCL) data, and can be especially advantageously applied in the processing of print orders in the data format “Advanced Function Presentation” (AFP), developed by the company International Business Machines Corp. (IBM), or in the corresponding printer-side data format “Intelligent Printer Data Stream” (IPDS), with its known parameters, such as for example “formdef,” “pagedef,” or “class.”

For the production of a print order from a plurality of data files, it can in particular be provided to send a job control data file together with the print data files, specifying which data files are to be combined in which sequence to form a print order. Associated data files of a print order can in addition be sent in particular in one and the same directory with the associated subdirectories. The directories of the print server can in particular be produced using a graphic user interface, and can be configured with respect to their standard processing parameters. A standard control data file can thereby be allocated to the directory.

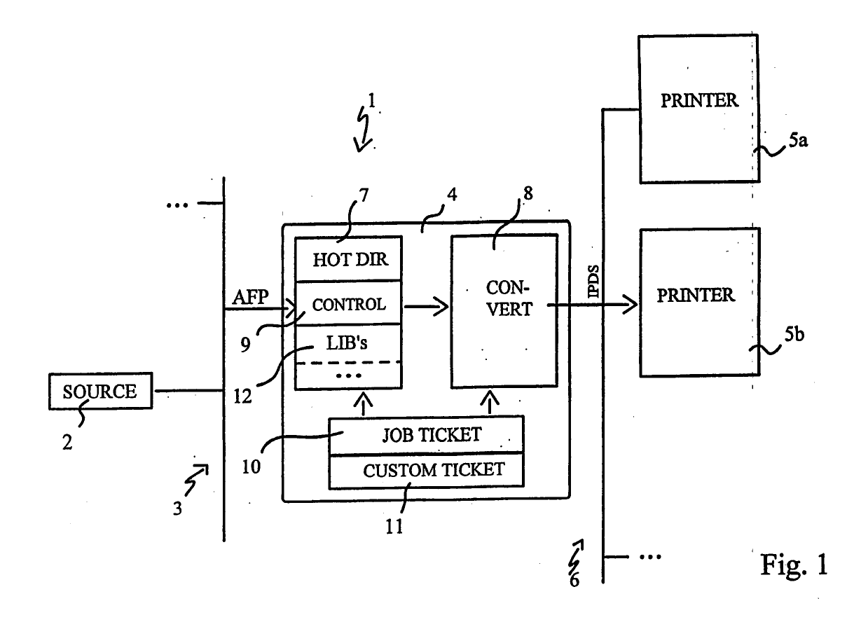

With reference now to the drawings, FIG. 1 shows a print system 1 in which print data from a data source 2, such as a host computer, a tape drive, a user computer, or the like, are sent to a the print server 4 via a first network 3. The data transmission thereby takes place by data files, whereby a plurality of data files can belong to a particular print order. For each print order, a particular memory area, i.e., a directory, is provided in the print server 4, in which all data files belonging to the print order are stored as soon as they arrive in the print server. For example, the data files of a current print order are temporarily stored in the directory “Hot dir” 7 of the print server 4. Inside the print server 4, the data of a print order are subsequently converted as needed into a data stream matched to the printer, in a conversion module. In the present example, a plurality of printer devices 5a and 5b are connected to the print server 4 via a second network 6, whereby the print data are transmitted between the print server 4 and print devices 5a and 5b in the printer-adapted language “IPDS” (Intelligent Printer Data Stream).

For the processing of a print job, the data file belonging to the order, or the corresponding plurality of data files, are sent from data source 2 to an intermediate memory 7 of the print server 4. The intermediate memory or directory 7 is checked at predetermined time intervals, which can be set, of for example two seconds, for newly added data files, in order to add the data files to an already-existing print order or to automatically produce a new print order from the added data files. For this purpose, in a control program 9 various parameters can be set that contain the control information for processing the print order, namely the items of job ticket information that are stored in a job ticket data file 10.

In addition, in the control program 9 it can be selected and allocated which data and/or accompanying data are contained in the print data files that are sent to the print server 4 from the data source 2, as follows:

In a first setting, it is determined that a further parameter relates to items of custom ticket information that are stored in a custom ticket data file 11 and that replace those parameters of the job ticket 10, having order-specific values, that are indicated in the custom ticket data file 11.

In a second setting, it is determined that only data are transmitted that are all allocated to the same predefined options and/or operating steps indicated in the job ticket data file 10.

In a third setting, it can be determined that the respectively transmitted print data files have stored in their data file names items of information that overwrite the predefined values of the job ticket data file 11 for the print data contained in the transmitted data file.

The intermediate storage directory 7 is examined at predetermined time intervals, and the added data files are then further processed on the basis of the respectively valid parameters of the job ticket, of the custom ticket, or of the parametrized data file names. For subsequent conversion or print processes, for example library data can be made available from a library memory 12. From the individual data files that have been added in the print server 4, an output-side print data stream, which is adapted to the connected print devices 5a and 5b and is for example in the IPDS format, is then produced via the conversion module 8.

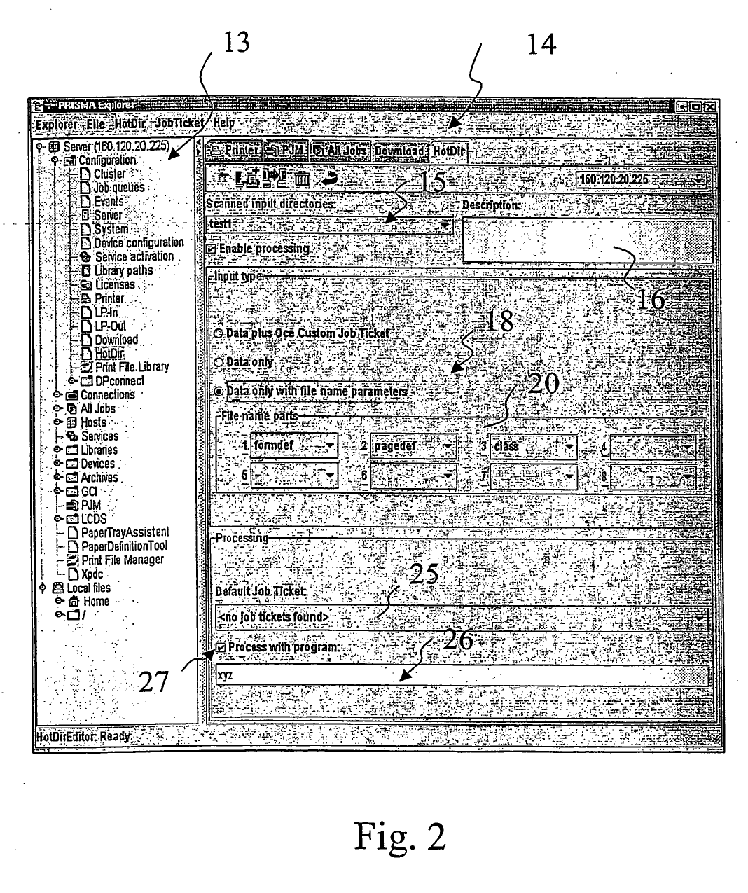

FIG. 2 shows a setting menu via which the processing mode, as well as associated parameters, can be determined. At the left edge of the window, various menu points are shown in a tree structure 13 of a the print server, while a selection menu 14 is shown in the center and right areas of the screen. Via a setting field 15, an arbitrary directory can be called or can be set up, in which incoming data files are temporarily stored. In a field 16, a more precise description can be inputted for the respective directory. With an activation field 17, it is determined whether the data files that have been added, or are temporarily stored, in the selected directory are to be combined according to the selected settings to form a print order. In a setting area 18, it is designed which mode is thereby to be set. In the first mode, “Data Plus Océ Custom Job Ticket,” it is determined that in addition to the print data files a client-specific control data file, the custom job ticket, is stored in the directory, in which particular processing parameters are set that differ from the standard control data files (default job ticket) selected in field 25. In the second setting field of a selection menu 18, “Data only,” it is determined that only print data are stored in the selected temporary storage directory “Test 1,” so that these data are processed completely with the control information set in a field 25, “Standard Job Tickets.” In the third selection field of the setting area 18, “Data only with filename parameters,” it is determined that the data files stored in the selected directory “Test 1” respectively contain control parameters in their data filenames. The details of these data file name parameters are indicated in a parameter field 20, whereby in the example shown here the first field, which is separated from the following field by a point, contains an indication of the format definitions “formdef” contained in the library 12, while the second field contains the page definitions “pagedef” contained in the library is 12, etc. For example, the indication “flxy.p1xy.4 Hallo” in the data file name would indicate that the formdef data file “flxy” is to be used, as are the pagedef data file “plxy” and the class “4”.

As already indicated above, in the setting field 25 it is determined which standard control data file is allocated to the selected temporary storage directory “Test 1”; that is, with which control parameters the data files stored therein are standardly processed, insofar as nothing different of a higher priority is written by the parameters of a custom job ticket control data file or by data filename parameters. In addition, in the setting window 26 and the associated activation field 27 it can be indicated with which other processing program the data files are to be processed in the production of the print order. For example, it can thereby be provided to convert data files of a particular format (e.g., GIF) into a different format, for example into a container of the AFP printer language, before it is supplied to further processing as a print order.

Exemplary embodiments of the present invention have been described. It is clear that someone skilled in the art can easily indicate further developments or modifications without deviating from the concept of the present invention. For example, instead of the indicated printer languages AFP and IPDS other printer languages can also be used, such as for example PostScript, Page Command Language (PCL), or the like, which are within the standard competence of someone skilled in the art.

Although the present invention has predominantly been described with program modules of the print server, it is clear that corresponding program modules can also be used in the area of the data source (resource, magnetic tape, host computer, client computer . . . ) that work together with the program modules of the print server. The program modules are thereby connected with one another, in terms of control technology, in such a way that in the area of the data source the data files, additional data files, and/or data file designations are provided in such a way that they can be correspondingly read and interpreted in the print server 4 by the control program 9, in order to enable rapid and flexible execution of the further processing of data in order to produce the print order.

Although the exemplary embodiments have been described on the basis of print orders, the present invention can also be used to handle document processing orders of a general nature. For example, resource data files or electronic documents (which can also include for example software programs and their updates) that are to be sent from a first system to a second system for print orders or document processing orders can be sent to the second system quickly and flexibly. The data files can thereby be almost arbitrarily configurably converted, further processed and/or subjected to an additional processing, and can be stored in the second system in an arbitrary directory. The processing data can thereby in particular also be designated as document data.

The present invention is in particular suitable for realization as a computer program (software). It can thus be distributed as a computer program module, as a data file on a data medium such as a diskette or CD-ROM, or as a data file via a data or communication network. Such computer program products or computer program elements, and comparable ones, represent constructions of the present invention. The inventive sequence can be applied in a computer, in a printing device, or in a printing system with data processing devices connected upstream or downstream. It is thereby clear that corresponding computers on which the present invention is used can contain additional devices known in themselves, such as input means (keyboard, mouse, touchscreen), a microprocessor, a data or control bus, a display means (monitor, display), as well as a working storage unit, a hard disk memory, and a network card. Although other modifications and changes may be suggested by those skilled in the art, it is the intention of the inventors to embody within the patent warranted hereon all changes and modifications as reasonably and properly come within the scope of their contribution to the art.

1-11. (canceled)

12. A method for automatic receiving and forwarding of a document processing order for processing at least one data file, comprising the steps of:
sending at least one data file to a directory of a receiving server;
automatically checking the directory at regular time intervals for newly added data files;
supplying each newly added data file for further processing;
controlling the checking step by a computer program;
permitting selection of a control mode from at least two settings selected from the following:
the data files contain only processing data,
the data files contain processing data and an order-individual control data file,
the data files contain processing data, and each data file has a parameterized data filename for further processing; and
allocating selected settings of the control mode to the directory.

13. A method as recited in claim 12, wherein the data files include parameterized data filenames that characterize at least one of options and operational steps for one of predetermined options and operational steps of predetermined parameters of a job ticket control data file that is standardly allocated to print order.

14. A method as recited in claim 12, wherein the document processing order is a print order and the receiving server is a the print server.

15. A method as recited in claim 12, wherein the data files are sent to the receiving server from a data source in a format that corresponds to the selected control mode.

16. A method as recited in claim 12, further comprising the step of:
permitting selection of a process program that subjects incoming data files to an additional processing before the data are added to the further processing.

17. A method as recited in claim 13, wherein the parameterized data filenames contain one of AFP or IPDS parameters.

18. A method as recited in claim 12, further comprising the step of:
combining a plurality of data files to form a print order by a job control data file.

19. A method as recited in claim 12, further comprising the step of:
storing associated data files of a document processing order are stored in one and the same directory with associated subdirectories.

20. A method as recited in claim 12, wherein using a graphic user interface, directories of the print server can be created and can be configured with respect to their standard processing parameters.

21. A receiving server for executing a method for automatic receiving and forwarding of a document processing order for processing at least one data file, comprising the steps of:
sending at least one data file to a directory of a receiving server;
automatically checking the directory at regular time intervals for newly added data files;
supplying each newly added data file for further processing;
controlling the checking step by a computer program;
permitting selection of a control mode from at least two settings selected from the following:
the data files contain only processing data,
the data files contain processing data and an order-individual control data file,
the data files contain processing data, and each data file has a parameterized data filename for further processing; and
allocating selected settings of the control mode to the directory.

22. A computer program module for executing a method for automatic receiving and forwarding of a document processing order for processing at least one data file, comprising the steps of:
sending at least one data file to a directory of a receiving server;
automatically checking the directory at regular time intervals for newly added data files;
supplying each newly added data file for further processing;
controlling the checking step by a computer program;
permitting selection of a control mode from at least two settings selected from the following:
the data files contain only processing data,
the data files contain processing data and an order-individual control data file,
the data files contain processing data, and each data file has a parameterized data filename for further processing; and
allocating selected settings of the control mode to the directory.
